(19) United States
(12) Patent Application Publication
(10) Pub. No.: US 2025/0314938 A1
(43) Pub. Date: Oct. 9, 2025

(54) Electrochromic arrangement for a long-range optical device

(71) Applicant: STEINER-OPTIK GmbH, Bayreuth (DE)

(72) Inventors: Robert Polster, Bayreuth (DE); David Amschler, Bayreuth (DE); Oliver Jäschke, Bayreuth (DE)

(21) Appl. No.: 18/867,902

(22) PCT Filed: May 23, 2023
(86) PCT No.: PCT/EP2023/063775

§ 371 Date: Nov. 21, 2024

(30) Foreign Application Priority Data
May 24, 2022 (DE) 10 2022 113 130.0

(51) Int. Cl. G02F 1/155; G02F 1/161

(52) U.S. Cl. CPC G02F 1/155; G02F 1/161

(57) ABSTRACT

An electrochromic arrangement for a long-range optical device, including at least one electrochromic element formed by or including an electrochromic material arranged or formed between two electrically conductive elements, including at least one substrate element with a substrate element body having a disk-type or disk-shaped basic shape, wherein a contact layer made of an electrically conductive material and extending at least in sections around the edge of the substrate element body is applied to the upper or lower side of the substrate element body by means of a chemical and/or physical application method.

The invention relates to an electrochromic arrangement for a long-range optical device, which electrochromic arrangement comprising at least one electrochromic element formed by or comprising an electrochromic material arranged or formed between two electrically conductive elements.

The integration of corresponding electrochromic arrangements, comprising at least one electrochromic element formed by or comprising an electrochromic material arranged or formed between two electrically conductive elements, in long-range optical devices, such as binoculars, is known in principle from the prior art.

Corresponding electrochromic arrangements typically serve as a module integrated into an optical channel of a respective long-range optical device to specifically change the brightness and/or contrast of a field of view, so that a user can use the respective long-range optical device largely glare-free even in special or possibly changing lighting conditions, i.e., for example, in very bright and/or high-contrast lighting conditions.

The integration of corresponding electrochromic devices into a long-range optical device generally poses a challenge due to the limited free installation space available. In particular, practicable and reliable electrical contacting of the electrochromic arrangement, which in turn has an influence on the efficiency of the changes in brightness and/or contrast that can be brought about by the electrochromic elements, represents a challenge.

The technical approaches available to date for integrating corresponding electrochromic devices into a long-range optical device are therefore in need of improvement or further development.

The object underlying the present invention is that of providing an improved electrochromic arrangement for a long-range optical device.

The object is achieved by an electrochromic arrangement for a long-range optical device according to the independent claim 1. The claims dependent thereon relate to possible embodiments of the electrochromic arrangement.

A first aspect of the invention relates to an electrochromic arrangement for a long-range optical device, such as for binoculars (monocular or binocular), a telescopic sight, a night vision device, etc. The electrochromic arrangement thus represents an assembly which can be structurally integrated into a corresponding long-range optical device. In particular, the electrochromic arrangement is an assembly which can be structurally integrated into an optical channel of a long-range optical device, in particular an optical channel extending within an optical tube of a corresponding long-range optical device between an objective lens and an eyepiece.

The electrochromic arrangement generally comprises at least one electrochromic element arranged or formed between two electrically conductive elements—this can form an electrode of the electrochromic arrangement—which is formed by or comprises at least one electrochromic material.

Corresponding electrically conductive elements can be formed by or comprise electrically conductive layers or coatings, i.e. in particular transparent, electrically conductive layers or coatings. In particular, corresponding electrically conductive elements can be formed as transparent, electrically conductive layers or coatings on transparent substrate elements, e.g. made of glass or (transparent) plastic, or comprise such layers or coatings. Corresponding electrically conductive elements can therefore be applied to a substrate element as an electrically conductive layer or coating, at least in sections or, if necessary, completely.

A corresponding electrically conductive layer or coating of the electrochromic arrangement can be, for example, a coating formed by or comprising at least one transparent conductive oxide. Specifically, a corresponding electrically conductive layer or coating can be, for example, a coating formed by indium tin oxide (ITO)—as an example of a transparent conductive oxide—or a coating comprising ITO, in short an ITO coating. Transparent conductive oxides, such as ITO, are typically characterized by a comparatively high electrical conductivity (typically 104 S/cm) and a high optical transmission (>90% at a layer thickness of 100 nm) in the visible wavelength range and are therefore particularly suitable for forming corresponding electrically conductive coatings of the electrochromic arrangement described herein.

A corresponding electrochromic element of the electrochromic arrangement may, for example, be or comprise at least one layer or coating formed by or comprising at least one electrochromic material. An electrochromic material can, for example, undergo a change in its transmission, e.g. by an increase or decrease in its color or color intensity, when an electrical voltage or an electrical current is applied. A corresponding electrochromic material can therefore be regarded as an electrically switchable electrochromic material, for example. Specifically, an electrochromic material may be, for example, a redox-active material, i.e. in particular a redox-active compound, or comprise at least one such material which undergoes a change in its transmission during a redox process, such as a transition from an oxidized to a reduced state (and vice versa). A corresponding redox-active material can be or comprise a metal complex compound, e.g. based on tungsten oxide (WO₃), which undergoes a change in its transmission during a redox process, such as a transition from the oxidized to the reduced state (and vice versa). Alternatively or additionally, metallo-supramolecular polyelectrolytes ((FE-)MEPE), for example, can be considered as electrochromic materials. In all cases, a respective electrochromic material can be embedded in an embedding material.

If the electrochromic arrangement comprises several corresponding electrochromic elements, at least one layer or coating of an electrolyte material, in particular a liquid or gel-like electrolyte material, e.g. based on a metal salt, can be arranged or formed between these electrochromic elements.

For making electrical contact with the at least one electrochromic element, i.e. in particular for applying an electrical voltage or an electrical current to the at least one electrochromic element, the electrochromic arrangement comprises at least one contact layer made of an electrically conductive material. A special feature of the electrochromic arrangement described herein is the configuration of the at least one contact layer, which is explained in more detail below:

As mentioned, the electrochromic arrangement comprises at least one substrate element formed, for example, from glass or a (transparent) plastic. Although the particular configuration of the at least one contact layer of the electrochromic arrangement serving for electrical contacting is described below in particular in connection with a substrate element, the following explanations apply analogously to each substrate element and each contact layer of the electrochromic arrangement. The electrochromic arrangement generally comprises at least two substrate elements and two corresponding contact layers, which typically have at least a similar, in particular an identical, configuration.

The at least one substrate element consists of a substrate element body. The substrate element body has a basic shape which can be integrated into an optical tube of a long-range optical device. Consequently, shape-determining geometric-constructive parameters, such as dimensions, of the substrate element body are typically selected with regard to the installation space available in a long-range optical device for proper integration.

Since the electrochromic arrangement can typically be arranged within an optical tube of a long-range optical device, the geometric-constructive parameters of the substrate element body of the at least one substrate element are typically selected with regard to the installation space available in an optical tube. In this respect, substrate element bodies with a circular disk-type or circular basic shape are particularly suitable. The substrate element body, which is typically made of transparent material such as glass or plastic, is therefore typically configured in the shape of a circular disk. However, other configurations are also conceivable in principle, such as disk-type or disk-shaped substrate element bodies with a polygonal, i.e. triangular, square, pentagonal, hexagonal, heptagonal, octagonal, ninagonal, decagonal, eleven-cornered or dodecagonal basic shape.

In all cases, the substrate element body of the at least one substrate element is configured in a disk-type or disk-shaped manner and therefore has an upper side and a lower side, which individually or jointly define a main extension plane of the substrate element body. In addition to the electrically conductive layer or coating mentioned above, the contact layer, also mentioned above, made of an electrically conductive material, such as a metal, in particular a precious metal, such as gold, or a semi-precious metal, such as copper, is arranged or formed on the upper or lower side of the substrate element body. The contact layer is typically applied to the upper or lower side of the substrate element body of the at least one substrate element by means of a chemical and/or physical application method, in particular a chemical and/or physical deposition process, further in particular a chemical and/or physical vapor deposition process. The layer thickness of the contact layer can be in a range between 1 nm or 10 nm and 1000 nm, in particular in a range between 1 nm and 950 nm, further in particular in a range between 1 nm and 900 nm, further in particular in a range between 1 nm and 900 nm, further in particular in a range between 1 nm and 850 nm, further especially in a range between 1 nm and 800 nm, further especially in a range between 1 nm and 750 nm, further especially in a range between 1 nm and 700 nm, further especially in a range between 1 nm and 650 nm, further especially in a range between 1 nm and 600 nm, further especially in a range between 1 nm and 550 nm, further especially in a range between 1 nm and 500 nm, further especially in a range between 1 nm and 450 nm, further especially in a range between 1 nm and 400 nm, further especially in a range between 1 nm and 350 nm, further especially in a range between 1 nm and 300 nm, further in particular in a range between 1 nm and 250 nm, further in particular in a range between 1 and 200 nm, further in particular in a range between 1 nm and 150 nm, further in particular in a range between 1 nm and 100 nm, further in particular in a range between 1 nm and 50 nm. Instead of 1 nm, 2 nm, 3 nm, 4 nm, 5 nm, 6 nm, 7 nm, 8 nm, 9 nm or 10 nm, for example, could also be used as the respective lower limit. In principle, all of the aforementioned values can also be used individually or as upper or lower limits of a layer thickness interval.

The contact layer can be applied directly or indirectly to the upper or lower side of the substrate element body of the at least one substrate element. In the first alternative, a corresponding transparent, electrically conductive layer or coating is also arranged or formed on the upper or lower side of the substrate element body; the transparent, electrically conductive layer or coating can be arranged or formed in particular in regions on the upper or lower side of the substrate element body in which the contact layer does not extend. In the second alternative, a corresponding transparent, electrically conductive layer or coating is arranged or formed on the upper or lower side of the substrate element body, in particular over the entire surface, and the contact layer is arranged or formed at least in sections on the transparent, electrically conductive layer or coating.

The contact layer extends in a ring-type or ring-shaped manner, i.e. in particular in a ring-segment-like or ring-shaped manner, at least in sections around the edge or along the edge of the substrate element body of the at least one substrate element, which, as mentioned, has, for example, a circular disk-type or circular basic shape. The contact layer is thus configured as an electrically conductive layer that extends at least in sections, if necessary completely, around the edge or along the edge of the substrate element body. The contact layer can be a continuous, quasi-continuous or discontinuous electrically conductive layer; consequently, the contact layer can be a continuous, quasi-continuous or discontinuous electrically conductive layer extending around the edge or along the edge of the substrate element body.

The substrate element body is therefore not provided with the contact layer over its entire upper or lower side, but only in a section of the upper or lower side that extends around the edge. This results not only in advantages with regard to reliable electrical contacting of the electrochromic arrangement with an electrical power supply, such as a battery integrated in a long-range optical device, but also with regard to the application of an electrical voltage to the at least one electrochromic element, which occurs at least temporarily during operation of the electrochromic arrangement, when this element is contacted in a ring-type or ring-shaped manner. This leads to a particularly rapid and uniform change in the optical properties, i.e. in particular the transmission, of the electrochromic arrangement in a surprising manner, especially in contrast to contacting only at a point. The described arrangement or formation of the electrically conductive layer also enables a change in brightness or contrast largely circumferentially from “outside to inside” and excludes phenomena known from the prior art, such as coloration in the manner of a stage curtain. In addition, there are, for example, production-related advantages in that the at least one substrate element does not have to be provided with a contact layer over its entire surface in the area of the upper or lower side of the substrate element body, but only in the area of the edge.

Overall, this provides an improved electrochromic arrangement for a long-range optical device.

As mentioned, the contact layer extends in a ring-type or ring-shaped manner, in particular in a ring-segment-like or ring-shaped manner, i.e. with a ring-type or ring-shaped or ring-segment-like or ring-shaped basic shape, at least in sections around the edge or along the edge of the substrate element body of the at least one substrate element, which, as mentioned, typically has a circular disk-type or circular basic shape. The contact layer can extend around at least 25%, in particular around at least 30%, in particular around at least 35%, in particular around at least 40%, in particular around at least 45%, in particular around at least 50%, in particular around at least 55%, in particular around at least 60%, in particular around at least 65%, in particular around at least 70%, in particular around at least 75%, in particular around at least 80%, in particular around at least 85%, in particular around at least 90%, in particular around at least 95%, possibly even 100%, of the edge around or along the edge of the substrate element body (the above-mentioned values can also be regarded as upper or lower limits of intervals). The more completely the contact layer extends around the edge or along the edge of the substrate element body, the faster or more uniformly a change in the optical properties, i.e. in particular the transmission, of the electrochromic arrangement can be brought about. In this respect, the contact layer therefore typically extends by at least 50% around the edge or along the edge of the substrate element body of the at least one substrate element.

At this point, conceivable values for the width of a contact layer formed in the form of a ring (segment) or segment are also given by way of example; the width of the contact layer can therefore be, for example 0.1 mm, 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm (the above values can also be regarded as upper or lower limits of intervals).

Between the contact layer and the edge of the substrate element body of the at least one substrate element, there may be a defined free space, at least in sections, in which the contact layer does not extend. Consequently, the contact layer does not have to extend completely to the edge of the substrate element body at least in sections with regard to its radial extension (with respect to a symmetry or central axis of the substrate element body), but there can be a defined distance between the outer circumference of the contact layer, which as mentioned is configured in particular in the form of a ring (segment) or segment, and the actual edge of the upper or lower side of the substrate element body. The contact layer can thus be arranged or formed at least in sections at a defined distance, e.g. of 0.1 mm, 0.2 mm, 0.3 mm, 0.4 mm, 0.5 mm, 0.6 mm, 0.7 mm, 0.8 mm, 0.9 mm, 1 mm (the above-mentioned values can also be regarded as upper or lower limits of intervals), from the edge of the upper or lower side of the substrate element body. In this way, for example, the amount of material used to form the contact layer and thus the time required to apply the contact layer to the upper or lower side of the substrate element body can be reduced.

As mentioned, the contact layer is used in particular for contacting the electrochromic arrangement with an electrical power supply, i.e. generally with an electrical energy supply. The contact layer may therefore comprise a contact portion of the electrochromic arrangement that can be contacted by an electrical contact element, such as a wire, a strand, a cable, etc., that can be connected or is connected to the electrical power or energy supply.

A corresponding contact portion can, for example in order to ensure reliable contacting with a corresponding electrical contact element, have different dimensions than the other regions of the contact layer, in particular with regard to its radial extension in the direction of the edge of the upper or lower side of the substrate element body of the at least one substrate element. The contact portion can therefore be formed by or represent a radial extension of the contact layer (compared to the other areas of the contact layer), which extends in the circumferential direction around a certain area of the edge of the substrate element body, i.e. e.g. by at least 5%, in particular by at least 10%, further in particular by at least 15%, further in particular by at least 20%, further in particular by at least 25%, further in particular by at least 30%, further in particular by at least 35%, further in particular by at least 40%, further in particular by at least 45%, further in particular by at least 50%, circumferentially around or along the edge of the substrate element body. In the region of a corresponding contact portion, there is typically no corresponding electrically conductive layer or coating; consequently, the contact portion can be applied directly to the upper or lower side of the substrate element body of the at least one substrate element.

With regard to a simple as well as stable structural integration of the electrochromic arrangement into a long-range optical device, i.e. in particular into a corresponding optical tube of a long-range optical device, the edge of the substrate element body of the at least one substrate element can have at least one flattening. A corresponding flattening can be defined in particular by a line or straight line extending through at least two points on the edge of the substrate element body forming the outer circumference of the substrate element body. Further in particular, a corresponding flattening can be defined by a secant extending through at least two points on the edge of the substrate element body forming the outer circumference of the substrate element body. The shape of the substrate element body of the at least one substrate element need not therefore be a complete circular disk, since the edge of the substrate element body can have at least one corresponding flattening. A corresponding flattening of the substrate element body can likewise simplify the structural integration of the electrochromic arrangement into a long-range optical device, for example as the flattening can be used to implement an anti-rotation lock of the electrochromic arrangement in an optical tube of the long-range optical device.

Similarly, a corresponding flattening can form a functionalized interface of the electrochromic arrangement, as, as will be shown below, a special electrical contacting option of the electrochromic arrangement with an electrical power supply can be implemented in this way. This applies in particular if the contact portion is arranged or formed opposite the flattening of the substrate element body of the at least one substrate element. The contact portion and the flattening can thus be arranged or formed (essentially) offset by 180° in the circumferential direction with respect to the, as mentioned, in particular circular disk-type or circular basic shape of the substrate element body of the at least one substrate element. In a top view of the corresponding upper or lower side of the substrate element body of the at least one substrate element, the contact portion can thus be arranged or formed at the top, for example, and the flattening can be arranged or formed opposite at the bottom.

In a particularly compact arrangement which is expedient with regard to contacting the electrochromic arrangement with an electrical power supply, the electrochromic arrangement comprises two substrate elements, each of which comprises a substrate element body with a corresponding flattening and an electrical contact portion arranged or formed opposite the flattening. The substrate element bodies of the first substrate element and the second substrate element are arranged one above the other, with their contact layers facing each other, but cannot make electrical contact with each other in order to avoid short circuits. The respective contact layers can are located on top of each other in such a way that they can complement each other to form a closed ring; consequently, the contact layer arranged or formed on the substrate element body of a first substrate element can (also) extend in the circumferential direction in an area in which no contact layer extends on the substrate element body of a second substrate element. Typically, the superimposed arrangement of the substrate elements is also selected such that their respective contact portions are at least partially exposed, so that the electrochromic arrangement can be contacted with the electrical power supply both via the contact portion of the first substrate element and via the contact portion of the second substrate element. A first electrical contact element can connect the contact portion of the contact layer of a first substrate element to the electrical power supply and a second electrical contact element can connect the contact portion of the contact layer of a second substrate element to the electrical power supply.

In all embodiments, the at least one electrochromic element, which, as mentioned above, may be a layer or coating of an electrochromic material, may also be arranged or formed on the substrate element body of the at least one substrate element, wherein it covers the contact layer and the layer or coating of the electrically conductive material, which may also be arranged or formed on the respective upper or lower side of the substrate element body of the at least one substrate element, at least in sections, in particular completely.

In all embodiments, the electrochromic arrangement can also have at least one spacer element made of an electrically insulating material, such as a plastic, which is arranged or formed on at least one electrochromic element at least in sections or, if necessary, completely. The spacer element can have a ring-type or ring-shaped basic shape. The outer dimensions of a spacer element having a corresponding ring-type or ring-shaped basic shape may correspond to the outer dimensions of the substrate element body of the at least one substrate element, so that the spacer element lies flush on the substrate element body. Within the interior space defined by the ring-type or ring-shaped basic shape of the at least one spacer element, the aforementioned layer or coating of an electrolyte material can be arranged or formed. In particular, the spacer elements are configured to distance or separate the respective contact layers from each other so that they cannot make electrical contact.

The electrochromic arrangement can—this can in particular be independent of the aspect of a flattening of the substrate element bodies—in principle comprise several substrate elements or substrate element bodies, which can be arranged stacked on top of one another.

A second aspect of the invention relates to a long-range optical device, in particular binoculars or a telescopic sight, which comprises at least one electrochromic arrangement according to the first aspect of the invention, so that all embodiments in connection with the electrochromic arrangement according to the first aspect of the invention apply analogously to the long-range optical device according to the second aspect of the invention (and vice versa).

The electrochromic arrangement can thus be structurally integrated into the optical channel or tube of the long-range optical device, which typically extends between an eyepiece and an objective lens of the long-range optical device; thus arranged or formed in the optical channel or tube. In particular, the electrochromic arrangement can be arranged in a section of the optical channel or tube extending between an objective lens and an eyepiece.

The long-range optical device can comprise an optical output device, e.g. in the form of a display, for outputting optical information. The optical information that can be output via the optical output device, i.e. e.g. alphanumeric symbols, graphics, images, videos, etc., can be coupled into the optical channel of the long-range optical device via a coupling device, e.g. formed by a prism arrangement comprising one or more prisms or via a foil (nanorod) or comprising such a device. The electrochromic arrangement can be directly or indirectly associated with the optical output device so that, for example, the brightness and/or contrast of the optical information that can be output via the optical output device can be specifically changed via the electrochromic arrangement.

A third aspect of the invention relates to a method of manufacturing an electrochromic arrangement for a long-range optical device, in particular an electrochromic arrangement according to the first aspect of the invention, so that all embodiments in connection with the electrochromic arrangement according to the first aspect of the invention apply analogously to the method according to the third aspect of the invention (and vice versa).

The method comprises at least the steps, which may be carried out more than once: a) providing at least one substrate element, e.g. with a substrate element body having a circular disk-type or circular basic shape; b) applying a contact layer which is made of an electrically conductive material, e.g. copper, and extends at least in sections around the edge of the substrate element body to the upper or lower side of the substrate element body by means of a chemical and/or physical application method; c) arranging or forming at least one electrically conductive element, e.g. made of indium tin oxide (ITO), on the substrate element body in order to form an electrically conductive layer or coating; d) arranging or forming at least one electrochromic element formed by or comprising an electrochromic element on the substrate element body. In particular, steps b) and c) can be interchanged, so that it is possible for the electrically conductive layer or coating, which, as mentioned, can be an ITO layer, for example, to be arranged or formed on the substrate element body first and only then the contact layer.

As part of the method, it is possible in particular to arrange substrate elements configured as described above with a corresponding contact portion and a flattening arranged opposite it, one above the other, in particular in such a way that the respective contact portions are exposed and the respective contact layers are arranged relative to one another, in particular forming a closed ring, but do not make electrical contact with one another. To ensure that the respective contact layers do not contact each other electrically, the aforementioned spacer elements can be provided between the respective contact layers.

The method can also include a step of contacting respective exposed contact portions with an electrical power supply. For this purpose, the respective contact portions can each be contacted with the electrical power supply via an electrical contact element, such as a wire, a strand, a cable, etc.

The invention is explained again below with reference to the embodiments shown in the figures. It shows:

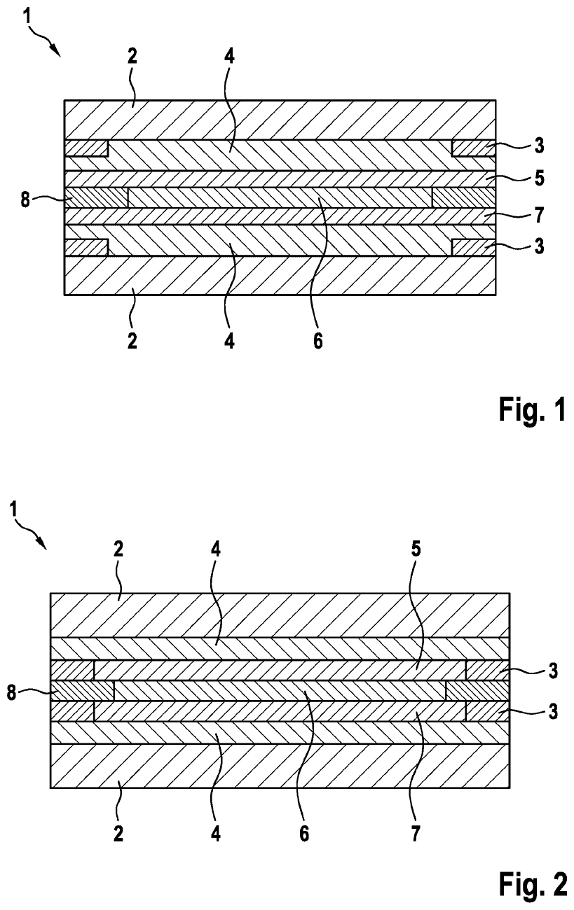

FIGS. 1, 2 each show a schematic diagram of an electrochromic arrangement according to an exemplary embodiment;

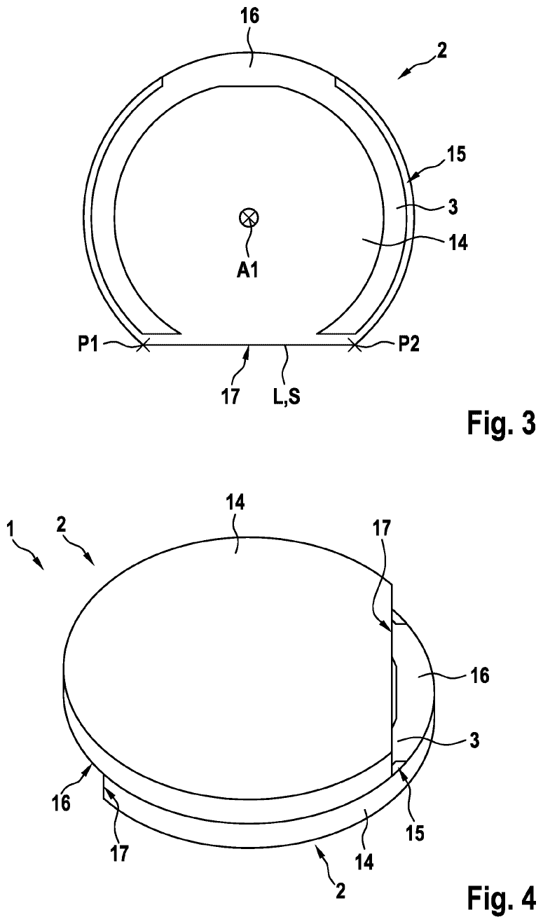

FIG. 3 a schematic representation of a substrate element of an electrochromic arrangement according to an exemplary embodiment;

FIG. 4 a schematic diagram of an electrochromic arrangement according to an exemplary embodiment; and

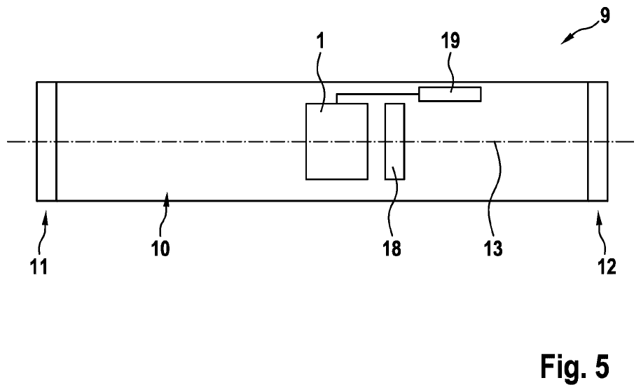

FIG. 5 a schematic representation of a long-range optical device comprising an electrochromic arrangement according to an exemplary embodiment.

FIGS. 1, 2 each show a schematic representation of an electrochromic arrangement 1 according to an exemplary embodiment, on the basis of which possible basic structures of the electrochromic arrangement 1 can be seen as examples and purely schematically.

According to the structure shown as an example in the exemplary embodiment in FIG. 1, the electrochromic arrangement 1 initially comprises, from top to bottom, a first substrate element 2 made of a transparent material, such as glass or plastics, on which a contact layer 3 made of an electrically conductive metal, such as copper, serving to contact the subsequently mentioned electrochromic materials with an external voltage supply, as well as a transparent, electrically conductive layer 4 made of a transparent, electrically conductive material, such as ITO, is arranged or formed. This is followed by a first layer 5 made of an electrochromic material, which can be referred to as the working electrode, a layer 6 made of an ion-permeable electrolyte material, e.g. in gel form, and a second layer 7 made of an electrochromic material serving as an ion storage layer, which can be referred to as the counter electrode. The layer structure is then repeated when the second layer 7 made of an electrochromic material is followed by a contact layer 3 made of an electrically conductive metal, such as copper, which serves to contact the aforementioned electrochromic materials with an external voltage supply, and a transparent, electrically conductive layer 4 made of a transparent, electrically conductive material, such as ITO, and a second substrate element 2. Spacer elements made of an electrically insulating material, such as plastic, are shown with reference sign 8.

According to the structure shown as an example in the exemplary embodiment according to FIG. 2, the electrochromic arrangement 1 comprises a modification to the structure shown in the exemplary embodiment according to FIG. 1, in particular in that a layer 4 of a transparent, electrically conductive material, such as ITO, is initially arranged or formed on the respective substrate elements 2, on which the respective contact layer 3 is also arranged or formed in addition to the respective layer 5, 7 of electrochromic material.

In all embodiments, the electrochromic arrangement 1 is intended for a long-range optical device 9, such as binoculars (monocular or binocular), a telescopic sight, a night vision device, etc., and thus represents an assembly which can be structurally integrated into a corresponding long-range optical device 9 (see FIG. 5). In particular, the electrochromic arrangement 1 is an assembly which can be structurally integrated into an optical channel 13 extending within an optical tube 10 of a corresponding long-range optical device 9 between an objective lens 11 nm and an eyepiece 12 (cf. FIG. 5).

As already indicated in connection with the exemplary embodiments according to FIGS. 1, 2, the electrochromic arrangement 1 comprises corresponding contact layers 3 made of an electrically conductive material for making electrical contact with the electrochromic element or elements typically present as a layer or coating 5, 7 made of an electrochromic material, i.e. in particular for applying an electrical voltage or an electrical current. A special feature of the electrochromic arrangement 1 described herein is the configuration of the contact layers 3, which is explained in more detail below with reference to FIGS. 3 and 4:

FIG. 3 shows an exemplary top view of the upper or lower side of a substrate element 2 of the electrochromic arrangement 1 according to an exemplary embodiment, whereby the following explanations in connection with the exemplary embodiment shown in FIG. 3 can apply analogously to all substrate elements 2 of the electrochromic arrangement 1.

The substrate element 2 consists of a substrate element body 14, which in the exemplary embodiment has an exemplary circular disk-type or circular basic shape. In principle, the substrate element body 14 has a basic shape which can be integrated into an optical tube 10 of a long-range optical device 9; consequently, shape-determining geometric-constructive parameters, such as dimensions, of the substrate element body 14 are selected with regard to the installation space available in a long-range optical device 9, i.e. in particular in the optical tube 10, for integration as intended.

As mentioned, the contact layer 3 formed by an electrically conductive material, such as a metal, in particular a precious metal, such as gold, or a semi-precious metal, such as copper, is arranged or formed on the upper or lower side of the substrate element body 14, which forms the main plane of extension of the substrate element 2. The contact layer 3 is typically applied to the upper or lower side of the substrate element body 14 by means of a chemical and/or physical application method, in particular a chemical and/or physical deposition process, further in particular a chemical and/or physical vapor deposition process. The layer thickness of the contact layer 3 can, for example, be in a range between 10 nm and 500 nm, in particular in a range between 10 nm and 450 nm, further in particular in a range between 10 and 400 nm, further in particular in a range between 10 nm and 350 nm, further in particular in a range between 10 nm and 300 nm, further in particular in a range between 10 nm and 250 nm, further in particular in a range between 10 nm and 200 nm, further in particular in a range between 10 and 150 nm, further in particular in a range between 10 and 100 nm, further in particular in a range between 10 and 50 nm.

It is evident that the contact layer 3 extends in a ring-type or ring-shaped manner, i.e. in particular in a ring-segment-like or ring-shaped manner, around the edge or along the edge of the substrate element body 14, which has a circular disk-type or circular basic shape. The contact layer 3 is thus configured as an electrically conductive layer extending at least in sections around the edge or along the edge of the substrate element body 14. In the exemplary embodiment according to FIG. 3, the contact layer 3 is shown as a continuous layer; in principle, quasi-continuous or discontinuous contact layers 3 are also conceivable; consequently, the contact layer 3 can generally be a continuous, quasi-continuous or discontinuous electrically conductive layer extending around the edge or along the edge of the substrate element body 14.

The substrate element body 14 is therefore not provided with the contact layer 3 over the entire surface in the area of its upper or lower side, but only in a section of the upper or lower side that extends around the edge. This results not only in advantages with regard to reliable electrical contacting of the electrochromic arrangement 1 with an electrical power supply, such as a battery integrated in a long-range optical device, but also with regard to the application of an electrical voltage to the electrochromic elements, which occurs at least temporarily during operation of the electrochromic arrangement 1, as these are contacted in a ring-type or ring-shaped manner, which leads to a surprisingly rapid and uniform change in the optical properties, i.e. in particular the transmission, of the electrochromic arrangement 1—particularly in contrast to contacting only at a point. Furthermore, there are advantages in terms of production technology, for example, as the substrate element 2 does not have to be provided with a contact layer 3 over its entire surface in the area of the upper or lower side of the substrate element body, but only around the edge.

As mentioned, the contact layer 3 extends ring-type or -shaped, i.e. in particular ring-segment-like or -shaped, i.e. with a ring-type or -shaped or a ring-segment-like or -shaped basic shape, at least in sections around the edge or along the edge of the substrate element body 14. In the exemplary embodiment shown in FIG. 3, the contact layer 3 extends around at least 50% of the edge circumferentially around or along the edge of the substrate element body 14. The more completely the contact layer 3 extends around the edge or along the edge of the substrate element body 14, the faster or more uniformly a change in the optical properties, i.e. in particular the transmission, of the electrochromic arrangement 1 can be brought about.

FIG. 3 also shows that there may be a defined free space 15 between the contact layer 3 and the edge of the substrate element body 14, at least in sections, in which the contact layer 3 does not extend. Consequently, the contact layer 3 does not have to extend completely to the edge of the substrate element body 14 in terms of its radial extension (with respect to an axis of symmetry or central axis A1 of the substrate element body 14), at least in sections, but there can be a defined distance, e.g. of 0.5 mm, between the outer circumference of the contact layer 3 and the actual edge of the upper or lower side of the substrate element body 14.

FIG. 2 also shows that the contact layer 3 can comprise a contact portion 16 that can be contacted by an electrical contact element, such as a wire, a strand, a cable, etc., that can be connected to the electrical voltage or power supply.

FIG. 3 also shows that the contact portion 16, for example to ensure reliable contacting with a corresponding electrical contact element, has different dimensions than the other regions of the contact layer 3 with respect to its radial extension in the direction of the edge of the upper or lower side of the substrate element body 14. The contact portion 16 can thus be formed by or represent a radial extension of the contact layer 3 (compared to the other areas of the contact layer 3), which extends circumferentially around a certain area of the edge of the substrate element body, i.e. for example by at least 10%, around or along the edge of the substrate element body 14. The contact portion 16 can be applied directly to the upper or lower side of the substrate element body 14; in the area of the contact portion 16, therefore, there does not have to be a corresponding transparent, electrically conductive layer or coating.

FIG. 3 further shows that the edge of the substrate element body 14 can have a flattening 17. In particular, the flattening 17 can be defined by a straight line L or a corresponding secant S extending through two points P1, P2 on the edge of the substrate element body 14 forming the outer circumference of the substrate element body 14. The shape of the substrate element body 14 need not therefore be a complete circular disk, since the edge of the substrate element body 14 can have a corresponding flattening 17. The flattening 17 can also simplify the structural integration of the electrochromic arrangement into a long-range optical device 9, for example as the flattening 17 can be used to secure the electrochromic arrangement 1 against rotation in an optical tube 10 of the long-range optical device 9.

Similarly, the flattening 17 can form a functionalized interface of the electrochromic arrangement 1 when, as can be seen further in connection with the exemplary embodiment according to FIG. 4, a special electrical contacting option of the electrochromic arrangement 1 with an electrical power supply can be implemented in this way. This applies in particular if, as shown in FIG. 3, the contact portion 16 is arranged or formed opposite the flattening 17. The contact portion 16 and the flattening 17 can therefore be arranged or formed (essentially) offset by 180° in the circumferential direction with respect to the circular disk-type or circular basic shape of the substrate element body 14. In the top view of the upper or lower side of the substrate element body 14 shown in FIG. 3, the contact portion 16 is thus arranged or formed at the top and the flattening 17 is arranged or formed opposite at the bottom.

Based on the exemplary embodiment according to FIG. 4, it can be seen that the electrochromic arrangement 1 has two correspondingly configured substrate elements 2, each of which has a substrate element body 14 with a corresponding flattening 17 and a contact portion 16 arranged or formed opposite the flattening 17. The substrate element bodies 14 of the first substrate element 2 and the second substrate element 2 are arranged one above the other, with their contact layers 3 facing each other, but cannot make electrical contact with each other in order to avoid short circuits. The respective contact layers 3 can lie on top of each other in such a way that they can complement each other to form a closed ring; consequently, the contact layer 3 arranged or formed on the substrate element body 14 of a first substrate element 2 (e.g. the upper substrate element in FIG. 4) can (also) extend in the circumferential direction in an area in which no contact layer 3 extends on the substrate element body 14 of a second substrate element 2 (e.g. the lower substrate element in FIG. 4). Obviously, the superimposed arrangement of the substrate elements 2 is also selected in such a way that their respective contact portions 16 are exposed at least in sections, so that the electrochromic arrangement 1 can be contacted with the electrical power supply both via the contact portion 16 of the first substrate element 2 and via the contact portion 16 of the second substrate element 2. A first electrical contact element can connect the contact portion 16 of the contact layer 3 of a first substrate element 2 (e.g. the upper substrate element in FIG. 4) to the electrical power supply and a second electrical contact element can connect the contact portion 16 of the contact layer 3 of a second substrate element 2 (e.g. the lower substrate element in FIG. 4) to the electrical power supply.

FIG. 5 shows a principle representation of a long-range optical device 9 according to an exemplary embodiment in a side view. An optical tube 10 is shown purely schematically, which comprises an objective lens 11 nm comprising one or more objective lenses (not shown) and an eyepiece 12 comprising one or more eyepiece lenses (not shown).

It is apparent that the electrochromic arrangement 1 is structurally integrated in the optical channel or tube 10 of the long-range optical device 9, which extends between the objective lens 11 nm and the eyepiece 11; consequently, the electrochromic arrangement 1 can be arranged or formed in the optical channel or tube 10 of the long-range optical device 9.

The long-range optical device 9 can comprise an optical output device 18, e.g. in the form of a display, for outputting optical information. The optical information that can be output via the optical output device 18, i.e. e.g. alphanumeric symbols, graphics, images, videos, etc., can be coupled into the optical channel of the long-range optical device via a coupling device, e.g. formed by a prism arrangement comprising one or more prisms or via a foil arrangement (in each case not shown) or comprising such a device. The electrochromic arrangement 1 can be directly or indirectly associated with the optical output device 18 so that, for example, the brightness and/or the contrast of the optical information that can be output via the optical output device 18 can be selectively changed via the electrochromic arrangement 1.

Reference sign 19 in FIG. 5 also indicates an electrical power supply integrated into the long-range optical device 9, e.g. in the form of a battery. Via the electrical power supply 19, voltages can be automatically applied to the electrochromic arrangement 1 by means of an associated hardware and/or software control device (not shown) or by means of an associated actuating device (not shown) on the user side, which leads to a corresponding change in transmission.

Finally, a method for manufacturing an electrochromic arrangement 1 for a long-range optical device 9 as shown in Fig. is explained.

The method comprises at least the following steps, which may be carried out more than once: a) providing at least one substrate element 2, e.g. with a substrate element body 14 having a circular disk-type or circular disk-shaped basic shape; b) applying a contact layer 3 which is made of an electrically conductive material and extends at least in sections around the edge of the substrate element body 14 to the upper or lower side of the substrate element body 14 by means of a chemical and/or physical application method; c) arranging or forming at least one electrically conductive element on the substrate element body 14 to form an electrically conductive layer or coating 4; d) arranging or forming at least one electrochromic element formed by or comprising an electrochromic material on the substrate element body 14. In particular, steps b) and c) can be interchanged, so that it is possible that the electrically conductive layer or coating, which, as mentioned, can be an ITO layer, for example, is first arranged or formed on the substrate element body 14 and only then the contact layer 3.

As part of the method, it is possible to arrange configured substrate elements 2 with a corresponding contact portion 16 and a flattening 17 arranged opposite it, one above the other, as described in connection with FIGS. 3, 4, in particular in such a way that the respective contact portions 16 are exposed and the respective contact layers 3 are arranged relative to one another, in particular forming a closed ring, but do not make electrical contact with one another. To ensure that the respective contact layers 3, 4 do not contact each other electrically, the aforementioned spacer elements 8 can be provided.

The method may further comprise a step of contacting respective exposed contact portions 16 with an electrical power supply. For this purpose, the respective contact portions 16 can each be contacted with the electrical power supply via an electrical contact element, such as a wire, a strand, a cable, etc.

1. An electrochromic arrangement for a long-range optical device, comprising at least one electrochromic element formed by or comprising an electrochromic material arranged or formed between two electrically conductive elements, wherein:
at least one substrate element with a substrate element body having a disk-type or disk-shaped basic shape, wherein a contact layer which is made of an electrically conductive material and extends at least in sections around the edge of the substrate element body is applied to the upper or lower side of the substrate element body by means of a chemical and/or physical application method.

2. The electrochromic arrangement according to claim 1, wherein the substrate element body has a circular disk-type or circular basic shape.

3. The electrochromic arrangement according to claim 1, wherein the contact layer has the shape of a ring or a ring segment.

4. The electrochromic arrangement according to claim 1, wherein the contact layer is arranged or formed at least in sections at a distance from the edge of the upper or lower side of the substrate element body.

5. The electrochromic arrangement according to claim 1, wherein the contact layer comprises a contact portion which can be contacted by an electrical contact element.

6. The electrochromic arrangement according to claim 5, wherein the contact portion is arranged or formed up to the edge of the upper or lower side of the substrate element body.

7. The electrochromic arrangement according to claim 1, wherein the edge of the substrate element body comprises at least one defined flattening.

8. The electrochromic arrangement according to claim 7, wherein the at least one flattening is defined by a line extending through at least two points on the edge of the substrate element body forming the outer circumference of the substrate element body.

9. The electrochromic arrangement according to claim 6, wherein the contact portion is arranged or formed opposite the flattening.

10. The electrochromic device according to claim 6, comprising a first and a second substrate element, wherein the edge of the substrate element body of the first substrate element comprises at least one corresponding flattening and comprises a contact portion arranged or formed opposite the flattening, and
the edge of the substrate element body of the second substrate element comprises at least one corresponding flattening and comprises a contact portion arranged or formed opposite the flattening, wherein
the substrate element bodies of the first and second substrate elements are arranged one above the other, wherein their respective contact layers do not make electrical contact with one another and wherein respective electrical contact portions are exposed at least in sections.

11. The electrochromic arrangement according to claim 1, comprising a spacer element arranged or formed on the electrochromic element and made of an electrically insulating material.

12. A long-range optical device, comprising at least one electrochromic arrangement according to claim 1.

13. A method of manufacturing an electrochromic arrangement for a long-range optical device, comprising at least the steps of:
a) providing at least one substrate element with a substrate element body having a disk-type or disk-shaped basic shape;
b) applying a contact layer, which is made of an electrically conductive material and extends at least in sections around the edge of the substrate element body, to the upper or lower side of the substrate element body by means of a chemical and/or physical application method;
c) arranging or forming at least one electrically conductive element, on the substrate element body;
d) arranging or forming an electrochromic element formed by or comprising an electrochromic material on the electrically conductive element.
